(19) United States
(12) Patent Application Publication
(10) Pub. No.: US 2026/0259526 A1
(43) Pub. Date: Sep. 3, 2026

(54) IMAGE FORMING APPARATUS

(71) Applicant: CANON KABUSHIKI KAISHA, Tokyo (JP)

(72) Inventor: RENA TAKAHASHI, Kanagawa (JP)

(21) Appl. No.: 19/550,693

(22) Filed: Feb. 26, 2026

(30) Foreign Application Priority Data
Feb. 28, 2025 (JP) 2025-032485

(51) Int. Cl. G03G 21/10; G03G 15/16; G03G 15/20; G03G 21/00

(52) U.S. Cl. CPC G03G 21/105; G03G 15/161; G03G 15/2017; G03G 15/2064; G03G 21/0005; G03G 2215/2038

(57) ABSTRACT

An image forming apparatus includes a single image forming portion including a plurality of discharging portions for discharging waste toners, and a fixing device including a heat rotatable member. A plurality of branch pipelines are connected to the discharging portions, respectively. The waste toners discharged from the discharging portions, respectively fall inside the branch pipelines, respectively. A merging pipeline is connected to the branch pipelines, respectively and receives the waste toners from the branch pipelines. The merging pipeline is located above the heat rotatable member with respect to a vertical direction and at a position overlapping with the heat rotatable member with respect to a horizontal direction. Any of the branch pipelines is located above the heat rotatable member with respect to the vertical direction and at a position nonoverlapping with the heat rotatable member with respect to the horizontal direction.

### BACKGROUND

### Field of the Technology

The present invention relates to an image forming apparatus comprising an image forming portion that forms a toner image on a recording material.

### Description of the Related Art

An image forming apparatus such as a printer which applies an electrophotographic type may be configured to include collecting pipeline passages which are provided with a plurality of branch pipeline passages which are respectively connected to a plurality of discharging portions for discharging waste toner and a merging pipeline passage which is connected to the plurality of branch pipeline passages. The plurality of discharging portions include, for example, a cleaning device which collects the waste toner from a photosensitive member or an intermediary transfer belt, or a developing device. The waste toner which is discharged from the plurality of discharging portions moves, respectively, through the branch pipeline passages to the merging pipeline passage. The waste toner which is moved to the merging pipeline passage is conveyed by a screw conveyance mechanism which is provided with the merging pipeline passage and collected in a common waste toner container.

In the image forming apparatus with such a configuration, in a case that the collecting pipeline passage is disposed within a range which is affected by heat from a fixing device, softened waste toner may accumulate on a pipeline wall, etc. and cause a problem in conveyance of the waste toner.

On the other hand, in Japanese Laid-Open Patent Application (JP-A) 2010-91750, a configuration, which includes a merging pipeline duct which is provided around the merging pipeline passage to form a double pipeline structure and a branch pipeline duct which is provided around the branch pipeline passage to form a double pipeline structure, is disclosed. Heated air inside the merging pipeline duct is exhausted outside a casing of the image forming apparatus through the branch pipeline duct by airflow which is generated by a airflow formation fan and natural convection.

In recent years, as processing speed of an image forming apparatus is increased, an amount of heat generation of the fixing device is tended to increase. On the other hand, as miniaturization of an image forming apparatus is required, it tends to become increasingly difficult to ensure a heat insulation barrier or sufficient distance between the collecting pipeline passage and the fixing device.

In a configuration in which the collecting pipeline passage is disposed in proximity to the fixing device, an effect of heat from the fixing device on the waste toner which contacts the pipeline wall of the collecting pipeline passage becomes significant. And especially inside the branch pipeline passage in which the waste toner drops down due to gravity, the waste toner softens and becomes more likely to accumulate on the pipeline wall. Therefore, the waste toner is likely to clog inside the branch pipeline passage.

A configuration which is described in JP-A 2010-91750 needs to mount a duct which encloses the collecting pipeline passage inside the casing of the image forming apparatus and it may lead to an increase of a device cost and an enlargement of a device configuration.

### SUMMARY

A principal object of the present invention is to provide an image forming apparatus capable of suppressing clogging of waste tonner in a branch pipeline passage.

Further, another object of the present invention is to provide an image forming apparatus comprising: a single image forming portion including a plurality of discharging portions for discharging waste toner and configured to form a toner image on a recording material; a fixing device including a heat rotatable member configured to apply heat to the recording material and configured to fix the toner image formed by the image forming portion onto the recording material; a plurality of branch pipeline passages connected to the plurality of the discharging portions, respectively, the waste toners discharged from the plurality of the discharging portions, respectively falling inside the plurality of the branch pipeline passages, respectively; and a merging pipeline passage connected to the plurality of the branch pipeline passages, respectively and configured to receive the waste toners from the plurality of branch pipeline passages, wherein the merging pipeline passage is located above the heat rotatable member with respect to a vertical direction and at a position overlapping with the heat rotatable member with respect to a horizontal direction, and wherein any of the plurality of branch pipeline passages is located above the heat rotatable member with respect to the vertical direction and at a position nonoverlapping with the heat rotatable member with respect to the horizontal direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view of an image forming apparatus.

FIG. 2 is a schematic sectional view of a fixing device.

FIG. 3 is a schematic perspective view of a waste toner collecting device.

FIG. 4 is a schematic sectional view of a collecting pipeline passage.

FIG. 5 is a schematic sectional side view showing a positional relationship between the collecting pipeline passage and the fixing device according to an embodiment.

FIG. 6 is a schematic sectional side view showing the positional relationship between the collecting pipeline passage and the fixing device in a modified example.

FIG. 7 is a schematic sectional view showing the positional relationship between the collecting pipeline passage and the fixing device according to the embodiment.

FIG. 8 is a schematic sectional side view showing the positional relationship between the collecting pipeline passage and the fixing device in a comparative example.

### DESCRIPTION OF THE EMBODIMENTS

In the following, the image forming apparatus according to the embodiment will be more specifically described with reference to Figures.

### First embodiment

### Image forming apparatus

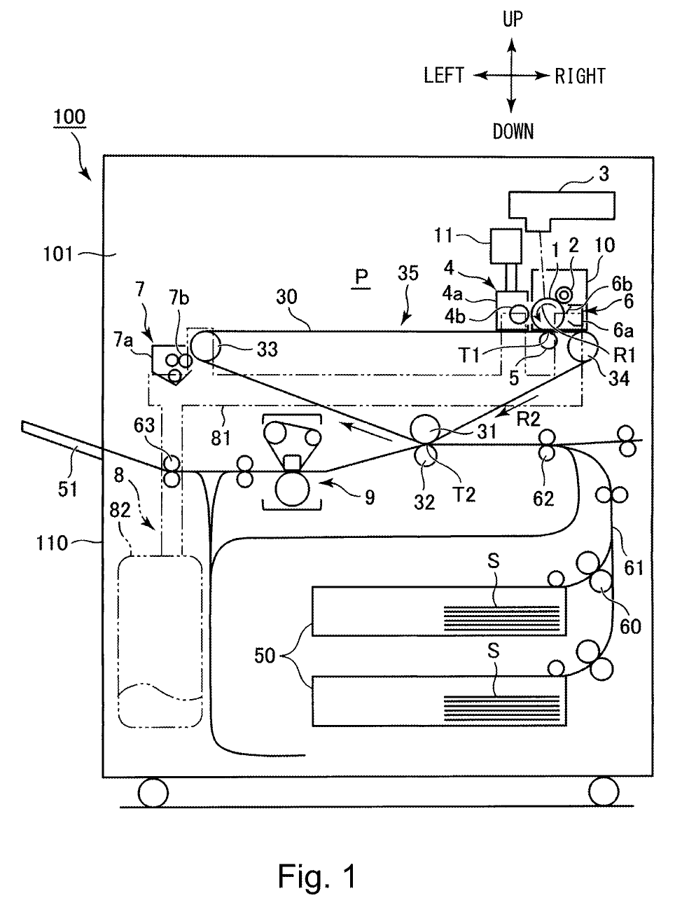

FIG. 1 is a schematic sectional view of an image forming apparatus 100 according to the embodiment. The image forming apparatus 100 according to the embodiment is a digital printer which applies an intermediary transfer type capable of forming an image of black (K) on a sheet shaped recording material S by using an electrophotographic type. The image forming apparatus 100 is possible to form an image based on image information which is transmitted from an external device such as a personal computer which is connected to the image forming apparatus 100, for example.

Incidentally, the image forming apparatus 100 will be described as it is mounted and used on a horizontal surface. A disposition, an orientation etc. of each portion in the image forming apparatus 100 which will be described below, are the disposition and the orientation in a case that the image forming apparatus 100 is mounted on the horizontal surface. For the image forming apparatus 100 and its elements, a front side of the drawing sheet of FIG. 1 is defined as a “front (front surface)” side, a rear side of the drawing sheet of FIG. 1 is defined as a “rear (back surface)” side, a right side of the drawing sheet of FIG. 1 is defined as a “right” side, and a left side of the drawing sheet of FIG. 1 is defined as a “left” side. A direction which is perpendicular to the drawing sheet of FIG. 1 (a front-back direction) connecting the front side and the rear side of the image forming apparatus 100 is assumed to be substantially parallel to a rotational axis direction of a photosensitive drum 1 which will be described below and rotational axis directions of stretching rollers for an intermediary transfer belt 30 which will be described below. Further, an up-down direction refers to up and down with respect to the direction of gravity (vertical direction), however, it does not mean only right above or right below, but it includes an upper side and a lower side of the horizontal surface which passes through a position or an element which is remarked.

The image forming apparatus 100 includes an image forming portion P which forms the image of black (K) on the recording material S. In the embodiment, the image forming portion P is configured to include the photosensitive drum 1, a charging roller 2, an exposure device 3, a developing device 4, a drum cleaning device 6, a developer replenishment device 11, an intermediary transfer unit 35, an outer secondary transfer roller 32, etc.

The photosensitive drum 1, which is a rotatable drum shaped (cylindrical) photosensitive member (electrophotographic photosensitive member) as a first image bearing member rotates in a direction of an arrow R1 (counterclockwise) in FIG. 1. A surface of the photosensitive drum 1 which is rotating is uniformly charged to a predetermined potential with a predetermined polarity (negative polarity in the embodiment) by the charging roller 2 which is a roller shaped charging member as a charging means. During charging, a charging voltage (charging bias) which includes a DC component of the same polarity as the charging polarity of the photosensitive drum 1 is applied to the charging roller 2. The surface of the photosensitive drum 1, which is charged, is scanned and exposed according to the image information (image signal) by the exposure device 3 as an exposure means, and an electrostatic latent image (electrostatic image) is formed on the photosensitive drum 1 according to the image information.

The electrostatic latent image which is formed on the photosensitive drum 1 is developed (visualized) when toner is supplied by the developing device 4 as a developing means, and a toner image (toner image, developer image) is formed on the photosensitive drum 1. In the embodiment, a two-component developer which includes toner (nonmagnetic toner particle) and carrier (magnetic carrier particle) as developer is used for the developing device 4. The developing device 4 includes a developer container 4a which accommodates the developer, and a developing sleeve 4b which is rotatably supported by the developer container 4a as a developer carrying member (developing member). The developing sleeve 4b conveys the developer toward the photosensitive drum 1 by rotating while carrying the developer. The developing device 4 supplies the toner onto the photosensitive drum 1 in accordance with the electrostatic latent image on the photosensitive drum 1 from the developer which is carried in the developing sleeve 4b. During developing, a developing voltage (developing bias) which includes a DC component of the same polarity as the charging polarity of the photosensitive drum 1 (negative polarity in the embodiment) is applied to the developing sleeve 4b. In the embodiment, the toner which is charged with the same polarity as the charging polarity of the photosensitive drum 1 adheres to an exposure portion on the photosensitive drum 1, in which an absolute value of potential has decreased by being exposed after being uniformly charged (reverse developing type). In the embodiment, the normal charging polarity of the toner, which is a primary charging polarity of the toner during development, is negative.

The intermediary transfer belt 30, which is an intermediary transfer member which is configured of an endless belt as a second image bearing member, is disposed so as to be opposed to the photosensitive drum 1. The intermediary transfer belt 30 is stretched over an inner secondary transfer roller 31, a tension roller 33, and a driving roller 34 as a plurality of stretching rollers. The intermediary transfer belt 30 rotates (circulating movement) in a direction of an arrow R2 (clockwise direction) in FIG. 1 when the driving roller 34 is rotated. On an inner peripheral surface side of the intermediary transfer belt 30, the primary transfer roller 5, which is a roller shaped primary transfer portion as a primary transfer means, is disposed at a position opposed to the photosensitive drum 1. The primary transfer roller 5 is pressed against the photosensitive drum 1 and forms a primary transfer portion (primary transfer nip) T1, which is a contacting portion between the photosensitive drum 1 and the intermediary transfer belt 30. The stretching rollers and the primary transfer roller 5 other than the driving roller 34 are rotated in accordance with the rotation of the intermediary transfer belt 30. The toner image which is formed on the photosensitive drum 1 is subjected to a predetermined pressure and an electrostatic bias by the primary transfer roller 5 at the primary transfer portion T1 and is transferred (primary transfer) onto the intermediary transfer belt 30 which is rotating. During primary transferring, a primary transfer voltage (primary transfer bias) with an opposite polarity to a normal charging polarity of a toner (positive polarity in the embodiment) is applied to the primary transfer roller 5. The toner which has not been transferred to the intermediary transfer belt 30 and remains on the photosensitive drum 1 during primary transferring (residual toner, transfer residual toner) is removed from the photosensitive drum 1 and collected by the drum cleaning device 6 as a photosensitive member cleaning means. Further, developer for replenishment which includes an amount of the toner corresponding to a portion which is consumed by the developing device 4 is replenished from the developer replenishment device 11 to the developing device 4.

On an outer peripheral surface side of the intermediary transfer belt 30, the outer secondary transfer roller 32, which is a roller shaped secondary transfer member as a secondary transfer means, is disposed at a position opposed to the inner secondary transfer roller 31 via the intermediary transfer belt 30. The outer secondary transfer roller 32 is pressed against the inner secondary transfer roller 31, and forms a secondary transfer portion (secondary transfer nip) T2, which is a contacting portion between the intermediary transfer belt 30 and the outer secondary transfer roller 32. The toner image which is formed on the intermediary transfer belt 30 is subjected to a predetermined pressure and an electrostatic bias by the secondary transfer roller 32 at the secondary transfer portion T2. In this way, the toner image on the intermediary transfer belt 30 is transferred (secondary transfer) onto the recording material S, which is being nipped and conveyed between the intermediary transfer belt 30 and the outer secondary transfer roller 32. During secondary transferring, a secondary transfer voltage (secondary transfer bias) with the opposite polarity to the normal charging polarity of the toner (positive polarity in the embodiment) is applied to the outer secondary transfer roller 32. The inner secondary transfer roller 31 is electrically grounded (connected to ground potential). Incidentally, it may be configured such that a secondary transfer voltage of the same polarity as the normal charging polarity of the toner is applied to a roller which corresponds to the inner secondary transfer roller 31 in the embodiment and a roller which corresponds to the outer secondary transfer roller 32 in the embodiment is electrically grounded. The toner which has not been transferred to the intermediary transfer belt 30 and remains on the intermediary transfer belt 30 during secondary transferring (residual toner, transfer residual toner) is removed from the intermediary transfer belt 30 and collected by a belt cleaning device 7 as an intermediary transfer member cleaning means.

The recording material (transfer material, sheet) S such as paper or plastic sheet, is accommodated such that it is stacked in a cassette 50 as a recording material accommodating portion. The recording material S is fed out from the cassette 50, in synchronism with timing of image forming, by a feeding roller 60 which is a feeding member as a feeding means, etc. The recording material S passes through a conveyance path 61 and is conveyed to a registration roller 62 which is a conveyance member as a conveyance means. The registration roller 62 corrects a tilt (inclination) of the recording material S which is conveyed, and conveys the recording material S to the secondary transfer portion T2 at a predetermined timing in synchronism with the toner image which is formed on the intermediary transfer belt 30.

The recording material S, onto which the toner image has been transferred, is conveyed to the fixing device 9 as a fixing means. The fixing device 9 fixes (melt, adhere) the toner image onto the recording material S by pressing and heating the recording material S which carries the toner image which has not been fixed. The recording material S, in which the toner image is fixed by the fixing device 9, is discharged (output) onto a discharge tray 51 as a discharge portion which is provided outside a casing 110 of the image forming apparatus 100 by a discharging roller 63 as a discharging member, etc.

In the embodiment, the photosensitive drum 1, the charging roller 2, and the drum cleaning device 6 configure a drum cartridge 10 which is integrally dismountable from a main assembly 101 of the image forming apparatus 100. Further, in the embodiment, the developing device 4 substantially independently configures a developing cartridge which is dismountable from the main assembly 101 of the image forming apparatus 100. Further, in the embodiment, the intermediary transfer belt 30, the stretching rollers for the intermediary transfer belt 30, the primary transfer roller 5, and the belt cleaning device 7 configure the intermediary transfer unit 35 which is integrally dismountable from the main assembly 101 of the image forming apparatus 100.

Further, the toner which is removed from the photosensitive drum 1 by the drum cleaning device 6 and the toner which is removed from the intermediary transfer belt 30 by the belt cleaning device 7 are collected by a waste toner collecting device 8.

### Cleaning device

Next, the cleaning devices (drum cleaning device 6, belt cleaning device 7) according to the embodiment will be furthermore described.

As shown in FIG. 1, the drum cleaning device 6 is disposed downstream of the primary transfer portion T1 (and upstream of a charging portion of the charging roller 2) with respect to a rotational direction of the photosensitive drum 1 (moving direction of a surface thereof). The drum cleaning device 6 includes a drum cleaning container 6a and a cleaning blade 6b as a cleaning member. The cleaning blade 6b is mounted on the drum cleaning container 6a so that it contacts the surface of the photosensitive drum 1. The drum cleaning device 6 slides the surface of the photosensitive drum 1 which is rotating by the cleaning blade 6b. In this way, the drum cleaning device 6 removes residual toner, paper dust, external additive, etc. which are adhered to the surface of the photosensitive drum 1 after they have passed through the primary transfer portion T1 from the photo sensitive drum 1, and collects them in the drum cleaning container 6a.

Further, as shown in FIG. 1, the belt cleaning device 7 is disposed downstream of the secondary transfer portion T2 (and upstream of the primary transfer portion T1) with respect to a rotational direction of the intermediary transfer belt 30 (moving direction of a surface thereof). In the embodiment, the belt cleaning device 7 is disposed in a position opposed to a tension roller 33 via the intermediary transfer belt 30. The belt cleaning device 7 cleans an image forming surface of the intermediary transfer belt 30. The belt cleaning device 7 includes a belt cleaning container 7a and a cleaning brush 7b as a cleaning member. The cleaning brush 7b is rotatably supported by the belt cleaning container 7a so as to rotate while contacting the surface of intermediary transfer belt 30. The belt cleaning device 7 slides the surface of the intermediary transfer belt 30 with the cleaning brush 7b. In this way, the belt cleaning device 7 removes residual toner, paper dust, external additive, etc. which are adhered to the surface of the intermediary transfer belt 30 after they have passed through the secondary transfer portion T2 from the surface of the intermediary transfer belt 30, and collects them in the belt cleaning container 7a. Incidentally, the belt cleaning device 7 may also be configured to include a cleaning blade as a cleaning member, which is provided to contact the surface of the intermediary transfer belt 30.

Here, the residual toner, the paper dust, the external additives, etc. which are collected by the drum cleaning device 6 or the belt cleaning device 7 are also referred to as “waste particle” or “waste toner.”

### Fixing device

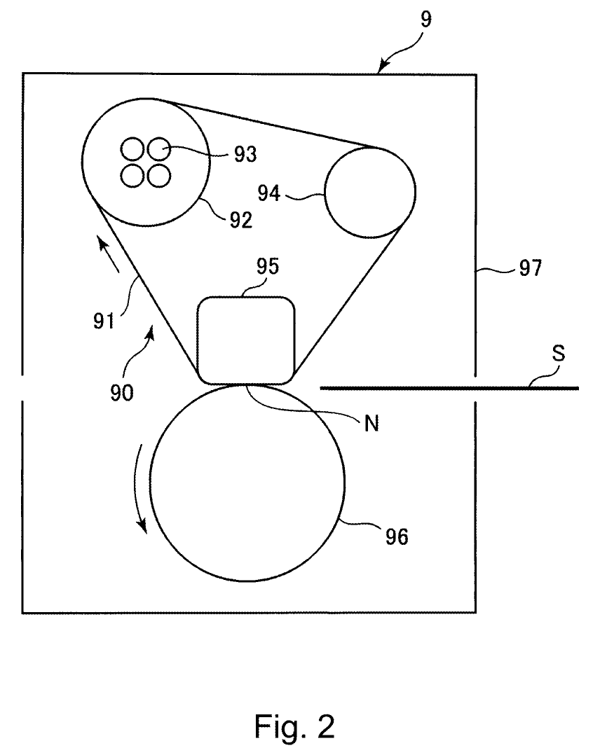

Next, the fixing device 9 according to the embodiment will be furthermore described. FIG. 2 is a schematic sectional view of the fixing device 9 according to the embodiment (showing a sectional view substantially perpendicular to the direction of the rotational axis of the photosensitive drum 1).

In the embodiment, the image forming apparatus 100 applies a belt heating type which uses an endless belt member as the fixing device 9. The fixing device 9 includes a heating unit 90 which applies heat to the recording material S, a pressing roller 96 as a pressing rotatable member, and a fixing device casing 97. The heating unit 90 and the pressing roller 96 are accommodated inside the fixing device casing 97. The heating unit 90 includes a fixing belt 91 as a heating rotatable member which is configured of a rotatable endless belt member, a heating roller 92, an auxiliary roller 94, and a pressing pad 95. The fixing belt 91 is stretched over the heating roller 92, the auxiliary roller 94, and the pressing pad 95. Further, the heating unit 90 includes a heater 93 as a heat source inside the heating roller 92 (hollow portion). The heat roller 92 contacts an inner peripheral surface of the fixing belt 91 and heats the fixing belt 91 by being heated by the heater 93. The fixing belt 91 is configured of a thin walled cylindrical belt member which exhibits thermal conducting properties, heat resisting properties, etc. The pressing roller 96 contacts the pressing pad 95 via the fixing belt 91 and forms a nip portion N with the fixing belt 91. Further, the pressing roller 96 is rotationally driven, and the fixing belt 91 is rotated in accordance with a rotation of the pressing roller 96 (circulating movement). In the nip portion N, the recording material S, which is nipped and conveyed between the fixing belt 91 which is heated by the heating roller 92 and the pressing roller 96 which presses against the fixing belt 91, is heated and pressed. In this way, the toner image is fixed (melt, adhere) onto the recording material S.

Incidentally, in the embodiment, the fixing device 9 is configured so that a heat source is only provided in the heating unit 90, however, it may also be configured so that the heat source is provided in the pressing roller 96 as well. Further, the fixing device 9 may be configured so that the recording material S is heated and pressed while the recording material S is nipped and conveyed between a heating roller as a heating rotatable member which is provided with a heat source such as a heater and a pressing roller as a pressing rotatable member which presses the heating roller.

### Waste toner collecting device

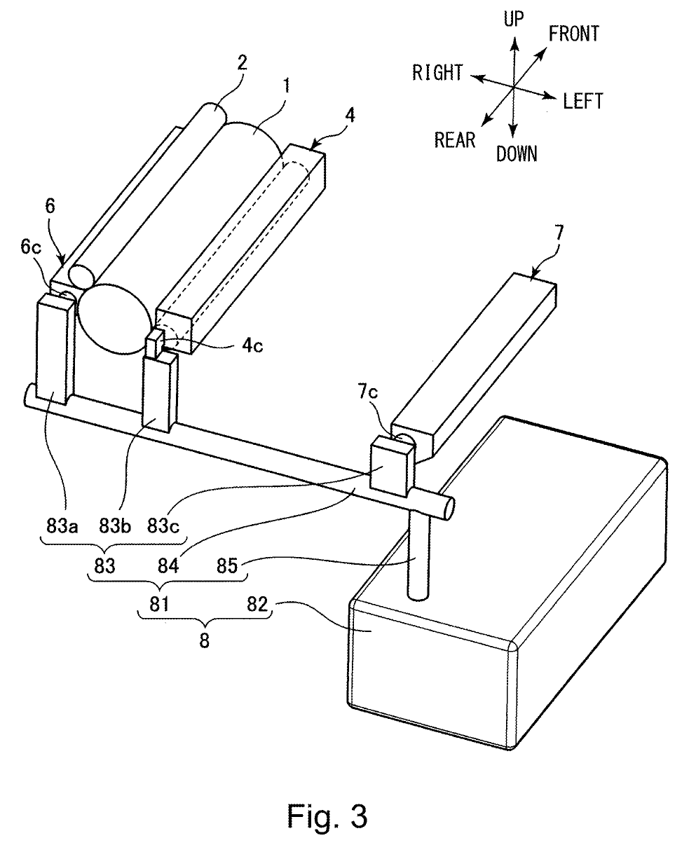

Next, the waste toner collecting device 8 according to the embodiment will be described. FIG. 3 is a schematic perspective view of the waste toner collecting device 8 when it is viewed from an oblique rear side of the image forming apparatus 100.

The waste toner collecting device 8 is configured to include a collecting pipeline passage (waste toner collecting pipeline passage) 81 and a waste toner container (collecting container) 82. The collecting pipeline passage 81 is configured to include a plurality of branch pipeline passages 83 (first branch pipeline passage 83a, second branch pipeline passage 83b, third branch pipeline passage 83c), a merging pipeline passage 84, and a connecting pipeline passage 85. The waste toner is merged into the merging pipeline passage 84 through the plurality of branch pipeline passages 83, and is collected into the waste toner container 82 from the merging pipeline passage 84 through the collecting pipeline passage 85. The waste toner container 82 is dismountable from the main assembly 101 of the image forming apparatus 100 and is replaced with an empty one in a case of becoming full, for example.

As described above, the residual toner which is remained on the photosensitive drum 1 is removed from the photosensitive drum 1 by the drum cleaning device 6, and is accommodated inside the drum cleaning container 6a of the drum cleaning device 6. The residual toner which is accommodated inside the drum cleaning container 6a, etc. is conveyed backward as the waste toner by a conveyance member (not shown) such as a conveyance screw which is provided inside the drum cleaning container 6a, etc. And, the waste toner is discharged into the first branch pipeline passage 83a, through a first discharging port 6c which is provided at an end portion of a rear side of the drum cleaning container 6a.

Further, in the embodiment, the developing device 4 applies the two-component developer as the developer, and the developer inside the developer container 4a of the developing device 4 includes not only the toner but also the carrier for charging the toner. Friction is generated when the toner and the carrier are stirred, and the toner is charged by static electricity. The toner is consumed during image forming. And, the developer for replenishment, which includes the amount of the toner corresponding to the portion which is consumed, is newly replenished from the developer replenishment device 11 to the developing device 4. On the other hand, the carrier may be deteriorated by being used for a long period of time in the developing device 4, since it is not consumed by image formation. Therefore, in the embodiment, the developer which includes the deteriorated carrier is discharged from the developing device 4, and the developer for replenishment, which includes an amount of the carrier corresponding to a portion which is discharged, is newly replenished from the developer replenishment device 11 to the developing device 4. The developer which includes the deteriorated carrier is conveyed backward as the waste toner by the conveyance member (not shown) such as the conveyance screw which is provided inside the developer container 4a, etc. And, the waste toner is discharged into the second branch pipeline passage 83b, through a second discharging port 4c which is provided at an end portion of a rear side of the developer container 4a.

Furthermore, as described above, the residual toner which is remained on the intermediary transfer belt 30 is removed from the intermediary transfer belt 30 by the belt cleaning device 7, and is accommodated inside the belt cleaning container 7a of the belt cleaning device 7. The residual toner which is accommodated inside the belt cleaning container 7a, etc. is conveyed backward as the waste toner by a conveyance member (not shown) such as a conveyance screw which is provided inside the belt cleaning container 7a, etc. And, the waste toner is discharged into the third branch pipeline passage 83c, through a third discharging port 7c which is provided at an end portion of a rear side of the belt cleaning container 7a.

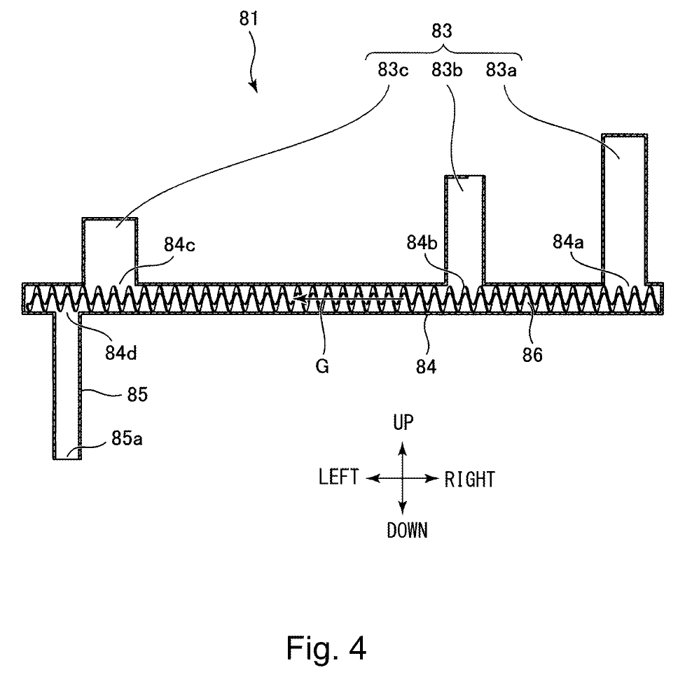

FIG. 4 is a schematic sectional view of the collecting pipeline passage 81 according to the embodiment (showing a sectional view from a front side when it is cut substantially parallel to the direction of gravity).

The first branch pipeline passage 83a, the second branch pipeline passage 83b, and the third branch pipeline passage 83c are connected to the merging pipeline passage 84. In the embodiment, the first branch pipeline passage 83a, the second branch pipeline passage 83b, and the third branch pipeline passage 83c extend substantially parallel to the direction of gravity. Further, in the embodiment, the merging pipeline passage 84 extends in a left-right direction substantially parallel to a horizontal direction. The merging pipeline passage 84 communicates with the first branch pipeline passage 83a at a first receiving port 84a. Further, the merging pipeline passage 84 communicates with the second branch pipeline passage 83b at a second receiving port 84b. Furthermore, the merging pipeline passage 84 communicates with the third branch pipeline passage 83c at a third receiving port 84c. The first receiving port 84a, the second receiving port 84b, and the third receiving port 84c are opened upward. In the first branch pipeline passage 83a, the second branch pipeline passage 83b, and the third branch pipeline passage 83c, any conveyance members (or crushing members), such as a conveyance screw, for conveying (or crushing) the waste toner from discharging from the first discharging port 6c, the second discharging port 4c, and the third discharging port 7c until merging into the merging pipeline passage 84, are not provided.

Further, in the embodiment, the connecting pipeline passage 85 is connected to the merging pipeline passage 84. In the embodiment, the connecting pipeline passage 85 extends substantially parallel to the direction of gravity. The merging pipeline passage 84 communicates with the connecting pipeline passage 85 at a drop port 84d. The drop port 84d is opened downward. The waste toner container 82 is connected to a connecting port 85a at an end portion which is on an opposite side of the drop port 84d of the connecting pipeline passage 85.

In the embodiment, the first discharging port 6c, the second discharging port 4c, and the third discharging port 7c are located on a back side of the intermediary transfer belt 30 with respect to the front-back direction. Further, in the embodiment, the first receiving port 84a, the second receiving port 84b, and the third receiving port 84c are located on the back side of the intermediary transfer belt 30 with respect to the front-back direction. Furthermore, in the embodiment, the drop port 84d and the connecting port 85a are located on the back side of the intermediary transfer belt 30 with respect to the front-back direction. And, in the embodiment, the first branch pipeline passage 83a, the second branch pipeline passage 83b, and the third branch pipeline passage 83c, the merging pipeline passage 84, and the connecting pipeline passage 85 are located on the back side of the intermediary transfer belt 30 with respect to the front-back direction.

A conveyance member 86 is provided inside the merging pipeline passage 84. In the embodiment, the merging pipeline passage 84 is configured of a circular pipe whose cross section, which is approximately perpendicular to its axis direction, is substantially circular. And, in the embodiment, the conveyance member 86 is configured of a conveyance screw (such as a shaftless screw). The first receiving port 84a is provided in a vicinity of an end portion on a upstream side with respect to a conveyance direction G of the waste toner inside the merging pipeline passage 84 by the conveyance member 86. The second receiving port 84b is provided on a downstream side of the first receiving port 84a with respect to the conveyance direction G of the waste toner inside the merging pipeline passage 84. Further, the third receiving port 84c is provided on a downstream side of the second receiving port 84b with respect to the conveyance direction G of the waste toner inside the merging pipeline passage 84. Furthermore, the drop port 84d is provided on a downstream side of the third receiving port 84c with respect to the conveyance direction G of the waste toner inside the merging pipeline passage 84, and is provided in a vicinity of an end portion on a downstream side with respect to the conveyance direction G of the waste toner inside the merging pipeline passage 84. Incidentally, the drop port 84d may be provided, for example, between the second receiving port 84b and the third receiving port 84c in the conveyance direction G of the waste toner inside the merging pipeline passage 84. In this case, the conveyance directions of the waste toner by the conveyance member 86 may be opposite to each other between a portion in which it is conveyed from a side of the first receiving port 84a and the second receiving ports 84b toward a side of the drop port 84d and a portion in which it is conveyed from a side of the third receiving port 84c toward a side of the drop port 84d. For example, the conveyance directions of the waste toner may be opposite to each other, when winding directions of blades of the conveyance screw as the conveyance member 86 which rotates in a predetermined direction are opposite to each other.

The waste toner, which is discharged from the drum cleaning device 6, the developing device 4, and the belt cleaning device 7 as the plurality of discharging portions, is discharged into the first branch pipeline passage 83a, the second branch pipeline passage 83b, and the third branch pipeline passage 83c through the first discharging port 6c, the second discharging port 4c, and the third discharging port 7c, respectively. The waste toner, which is discharged into the first branch pipeline passage 83a, the second branch pipeline passage 83b, and the third branch pipeline passage 83c, drops down by gravity inside the first branch pipeline passage 83a, the second branch pipeline passage 83b, and the third branch pipeline passage 83c, respectively. The waste toner which drops down inside the first branch pipeline passage 83a, the second branch pipeline passage 83b, and the third branch pipeline passage 83c moves into the merging pipeline passage 84 through the first receiving port 84a, the second receiving port 84b, and the third receiving port 84c, respectively. The waste toner which moves into the merging pipeline passage 84 is conveyed by the conveyance member 86, and moves into the connecting pipeline passage 85 through the drop port 84d. The waste toner, which moves into the connecting pipeline passage 85, drops down inside the connecting pipeline passage 85 by gravity, moves into the waste toner container 82 through the connecting port 85a, and is collected (accommodate, accumulate) inside the waste toner container 82.

Incidentally, in the embodiment, the first branch pipeline passage 83a, the second branch pipeline passage 83b, and the third branch pipeline passage 83c extend substantially parallel to the direction of gravity, however, it is not limited to this. At least one of the first branch pipeline passage 83a, the second branch pipeline passage 83b, and the third branch pipeline passage 83c may extend in the up-down direction (along the direction of gravity), while being inclined with respect to the direction of gravity within a range in which the waste toner is possible to move by gravity. An angle of the inclination is not limited to this, however, a range of 45 degrees or less with respect to the direction of gravity may be appropriate, and typically a range of 30 degrees or less may be appropriate. Further, in the embodiment, the merging pipeline passage 84 extends substantially parallel to the horizontal direction, however, it may also extend along a direction intersecting the direction of gravity while being inclined with respect to the horizontal direction within a range in which it can be conveyed appropriately by the conveyance member 86. An angle of the inclination is not limited to this, however, a range of 45 degrees or less with respect to the horizontal direction may be appropriate, and typically a range of 30 degrees or less may be appropriate. Further, in the embodiment, although the connecting pipeline passage 85 extends substantially parallel to the direction of gravity, however, it is not limited to this, but the connecting pipeline passage 85 may extend in the up-down direction (along the direction of gravity) while being inclined with respect to the direction of gravity within a range in which the waste toner is possible to move by gravity. An angle of the inclination is not limited to this, however, a range of 45 degrees or less with respect to the direction of gravity may be appropriate, and typically a range of 30 degrees or less may be appropriate. Further, in the embodiment, the collecting pipeline passage 81 is configured to include the connecting pipeline passage 85, however, it is not limited to this. For example, the collecting pipeline passage 81 may be configured so that it does not include the connecting pipeline passage 85 and the waste toner container 82 is directly connected to the merging pipeline passage 84. Further, in the embodiment, the first branch pipeline passage 83a, the second branch pipeline passage 83b, the third branch pipeline passage 83c, and the merging pipeline passage 84 are configured of separate members, however, at least one of the first branch pipeline passage 83a, the second branch pipeline passage 83b, the third branch pipeline passage 83c may be integrally configured with the merging pipeline passage 84. Further, in the embodiment, the waste toner collecting device 8 includes the conveyance member 86 as the conveyance means, which conveys the waste toner inside the merging pipeline passage 84, however, it is not limited to this. For example, the waste toner collecting device 8 may be configured to convey the waste toner inside the merging pipeline passage 84 by means of an air flow. In the case, the waste toner collecting device 8 is provided with an air blowing means, such as an air pump or fan, as a conveyance means.

### Positional relationship between collecting pipeline passage and fixing device

As described above, due to speed-up and miniaturization of the image forming apparatus, the collecting pipeline passage 81 tends to become more susceptible to an effect of heat from the fixing device 9. And, especially, since the conveyance member such as the conveyance screw are not provided, the waste toner, which is melted by the heat from the fixing device 9, is more likely to accumulate on an inner wall of the branch pipeline passage 83 through which the waste toner passes when it drops down due to gravity. Therefore, the waste toner is likely to clog inside the branch pipeline passage 83. That is, since any conveyance members (or crushing members) are not provided with the branch pipeline passage 83, it is not possible to crush the adhesion of the waste toner which is formed by the effect of the heat from the fixing device 9 and the waste toner is likely to clog.

Therefore, in the image forming apparatus 100 according to the embodiment, by the positional relationship between the branch pipeline passages 83 (83a, 83b, 83c) of the collecting pipeline passage 81 and the fixing device 9, the waste toner inside the branch pipeline passages 83 (83a, 83b, 83c) is not susceptible to the effect of the heat from the fixing device 9.

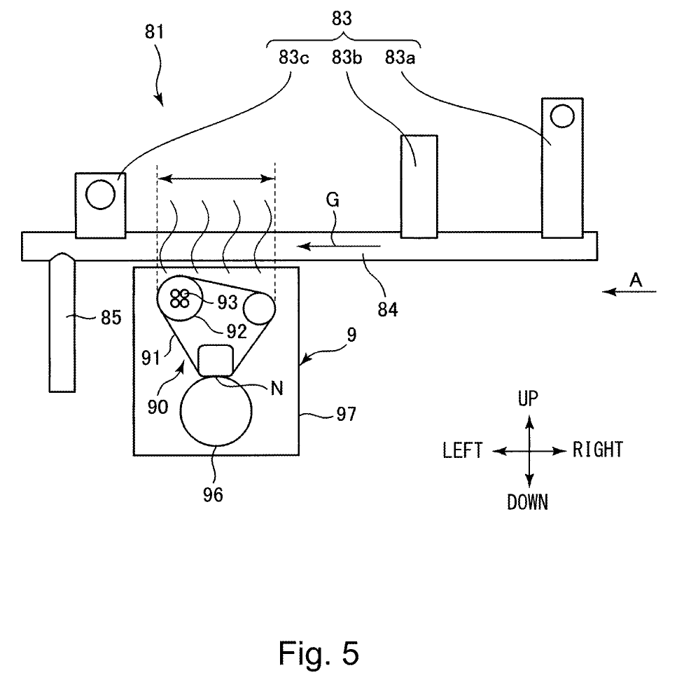

FIG. 5 is a schematic sectional view of the collecting pipeline passage 81 and the fixing device 9 according to the embodiment, when they are viewed from the front side. As shown in FIG. 5, the branch pipeline passages 83 (83a, 83b, 83c) and the merging pipeline passage 84 of the collecting pipeline passage 81 are located above the fixing device 9 in the direction of gravity. More specifically, the branch pipeline passages 83 (83a, 83b, 83c) and the merging pipeline passage 84 of the collecting pipeline passage 81 are located above the fixing belt 91 as the heating rotatable member with respect to the direction of gravity. And, the branch pipeline passages 83 (83a, 83b, 83c) are disposed at a position nonoverlapping with the heating device 90 of the fixing device 9 in a horizontal plane direction (front-back and left-right direction). That is, while the merging pipeline passage 84 extends across the heating unit 90 in the horizontal plane (front-back and left-right direction), the branch pipeline passages 83 (83a, 83b, 83c) are disposed at the position nonoverlapping with the heating unit 90. More specifically, the branch pipeline passages 83 (83a, 83b, 83c) of the collecting pipeline passage 81 are disposed at a position nonoverlapping with the fixing belt 91 as the heating rotatable member. That is, while the merging pipeline passage 84 extends across the fixing belt 91 in the horizontal plane, the branch pipeline passages 83 (83a, 83b, 83c) are disposed at the position nonoverlapping with the fixing belt 91 in the horizontal plane. Incidentally, a statement that a first element and a second element are nonoverlapping in a horizontal plane direction means, in other words, that an area in which the first element is projected and an area in which the second element is projected are not overlapped in a case that each of the first element and the second element is projected perpendicularly to the horizontal plane.

In the embodiment, the heating unit 90 is located between the second branch pipeline passage 83b and the third branch pipeline passage 83c in a direction in which the merging pipeline passage 84 is extended (the conveyance direction G of the waste toner inside the merging pipeline passage 84). That is, at least one of the branch pipeline passages 83 is provided on each side of the heating unit 90 in the direction in which the merging pipeline passage 84 is extended (the conveyance direction G of the waste toner inside the merging pipeline passage 84).

Heat which is generated from the heating device 90 of the fixing device 9 rises in a case that airflow is not formed by the airflow formation fan or the duct. By disposing the positional relationship between the collecting pipeline passage 81 and the fixing device 9 as described in the embodiment, it is possible to suppress the effect of the heat in which the branch pipeline passage 83 is received even without the airflow formation fan and the duct. Further, even in a case that the airflow formation fan or the duct is provided to discharge the air inside the casing 110 of the image forming apparatus 100 to the outside of the casing 110, for example, after the airflow formation fan is stopped, the heat which is generated from the heating device 90 of the fixing device 9 rises. By disposing the positional relationship between the collecting pipeline passage 81 and the fixing device 9 as described in the embodiment, it is possible to suppress the effect of the heat in which the branch pipeline passage 83 is received, even in a case that the airflow formation fan which is described above is stopped due to a power outage or jam (paper jam), for example. Further, since it is possible to suppress the effect of the heat in which the branch pipeline passage 83 is received by disposing the positional relationship between the collecting pipeline passage 81 and the fixing device 9 as described in the embodiment, it is possible to reduce a time until the airflow formation fan which is described above is stopped after image forming is complete.

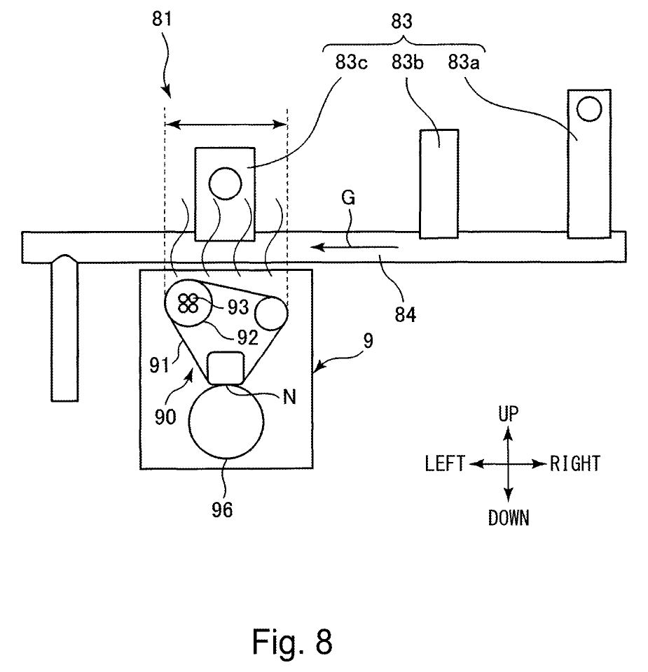

FIG. 8 is a schematic sectional view of the collecting pipeline passage 81 and fixing device 9 in a comparative example, when they are viewed from the front side. As shown in FIG. 8, in the comparative example, the branch pipeline passage 83 (the third branch pipeline passage 83c) of the collecting pipeline passage 81 is disposed at a position overlapping with the heating device 90 of the fixing device 9 in the horizontal plane direction. In the case, the heat which is generated from the heating device 90 of the fixing device 9 rises and heats the third branch pipeline passage 83c. Accordingly, since the conveyance member such as the conveyance screw is not provided, the waste toner, which is melted by the effect of the heat from the fixing device 9, is more likely to accumulate on an inner wall of the third branch pipeline passage 83c through which the waste toner passes when it drops down due to gravity. Therefore, the waste toner is likely to clog inside the third branch pipeline passage 83c.

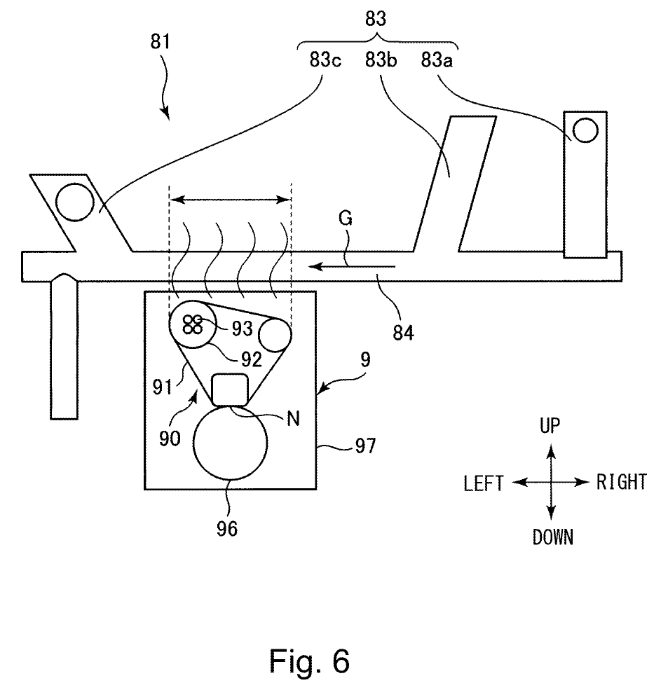

FIG. 6 is a schematic sectional view of the collecting pipeline passage 81 and fixing device 9 in a modified example of the embodiment, when they are viewed from the front side. As described above, the branch pipeline passages 83 (83a, 83b, 83c) may extend in the up-down direction while being inclined with respect to the direction of gravity. In the case as well, as shown in FIG. 6, the branch pipeline passage 83 (for example, the second branch pipeline passage 83b, the third branch pipeline passage 83c) is disposed at the position nonoverlapping with the heating unit 90 (the fixing belt 91) in the horizontal plane direction throughout its entire area from a lower end portion to an upper end portion. Further, in the case, as shown in FIG. 6, it is preferable that the branch pipeline passage 83 (for example, the second branch pipeline passage 83b, the third branch pipeline passage 83c) is extended while being inclined so that the upper end portion is located more remote from the heating unit 90 (the fixing belt 91) than the lower end portion. Therefore, it is possible to reduce the effect of the heat from the fixing device 9 on the branch pipeline passage 83.

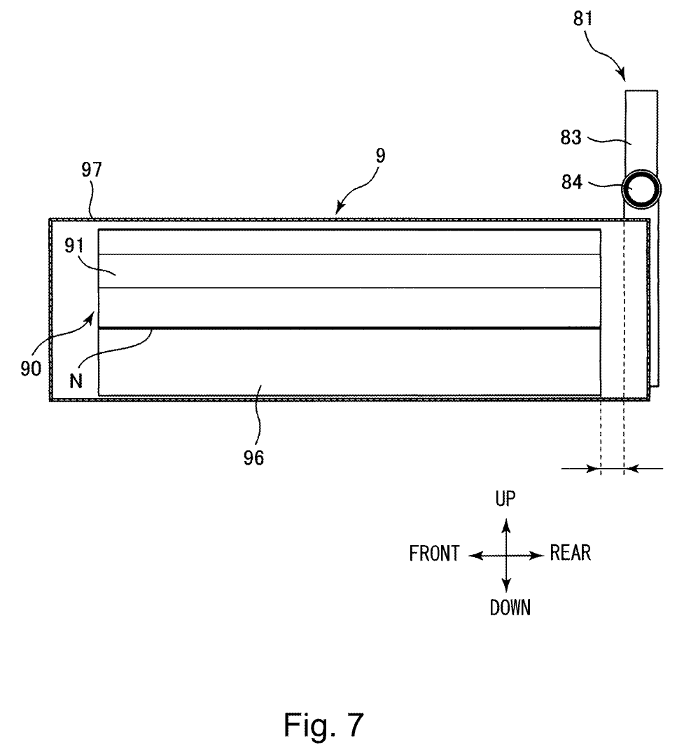

FIG. 7 is a schematic sectional view of the collecting pipeline passage 81 and the fixing device 9 according to the embodiment, when they are viewed from a right side (in a direction of an arrow A in FIG. 5) (that is when they are viewed in a direction in which the merging pipeline passage 84 extends). As shown in FIG. 7, in the embodiment, the collecting pipeline passage 81 and the fixing device 9 (the fixing device casing 97) are overlapped in the front-back direction (that is, the horizontal plane direction). However, in the front-back direction (that is, the horizontal plane direction), the collecting pipeline passage 81 and the heating unit 90 (the fixing belt 91) are not overlapped. Incidentally, the collecting pipeline passage 81 may be disposed at a position nonoverlapping with the fixing device 9 (the fixing device casing 97) in the front-back direction.

In this way, in the embodiment, the image forming apparatus 100 includes the image forming portion P including the plurality of discharging portions (the drum cleaning device 6, the developing device 4, the belt cleaning device 7) for discharging the waste toner, which forms the toner image on the recording material S, the fixing device 9 including the heat rotatable member (fixing belt) 91 which is configured to apply heat to the recording material S and configured to fix the toner image formed by the image forming portion P onto the recording material S, the plurality of the branch pipeline passages 83a, 83b, 83c connected to the plurality of the discharging portions 6, 4, 7 respectively, the waste toners discharged from the plurality of the discharging portions 6, 4, 7, respectively falling inside the plurality of the branch pipeline passages 83a, 83b, 83c, respectively, and the merging pipeline passage 84 connected to the plurality of the branch pipeline passages 83a, 83b, 83c, respectively and configured to receive the waste toners from the plurality of branch pipeline passages 83a, 83b, 83c, the conveying means (the conveying member) configured to convey the waste toner inside the merging pipeline passage 84, wherein the plurality of branch pipeline passages 83a, 83b, 83c and the merging pipeline passage are located above the heat rotatable member 91 and are located at the position nonoverlapping with the heat rotatable member 91 in the horizontal plane direction. In the embodiment, the merging pipeline passage 84 extends across the heat rotatable member 91 in the horizontal plane direction, and at least one of the branch pipeline passages 83a, the branch pipeline passage 83b, and the branch pipeline passage 83c is provided on each side of the heat rotatable member 91 along the direction in which the merging pipeline passage 84 extends. Further, in the embodiment, the fixing device 9 includes the casing (fixing device casing) 97 which accommodates the heat rotatable member 91, and at least one of the branch pipeline passages (in the embodiment, all of the plurality of branch pipeline passages 83a, 83b, 83c) and the merging pipeline passage 84 are disposed at the position overlapping with the casing 97 in the horizontal plane direction.

Further, in the embodiment, at least one branch pipeline passage (in the embodiment, all of the plurality of branch pipeline passages 83a, 83b, 83c) extends substantially parallel to the direction of gravity. However, at least one of the branch pipeline passage 83a, the branch pipeline passage 83b, and the branch pipeline passage 83c may extend in the up-down direction while being inclined with respect to the direction of gravity. In the case, it is preferable that at least one of the branch pipeline passage 83a, the branch pipeline passage 83b, and the branch pipeline passage 83c which extends in the up-down direction while being inclined with respect to the direction of gravity may be inclined so that the upper end portion is located more remote from the heat rotatable member 91 than the lower end portion. Further, in the embodiment, the image forming portion P includes a photosensitive member 1 on which the toner image is formed, the intermediary transfer belt 30 on which the toner image is transferred from the photosensitive member 1, a first cleaning device (drum cleaning device) 6 configured to collect the waste toner from the photosensitive member 1 and a second cleaning device (belt cleaning device) 7 configured to collect the waste toner from the intermediary transfer belt 30, and wherein the plurality of the discharging portions include the first cleaning device 6 and the second and the second cleaning device 7. Further, in the embodiment, the image forming portion P includes the developing device 4 configured to supply the toner to the photosensitive member 1 and form the toner image on the photosensitive member 1, and wherein the plurality of the discharging portions which are described above include the developing device 4.

As described above, in the embodiment, even when any conveyance members (or crushing members) are not provided with the branch pipeline passage 83, since the branch pipeline passage 83 is less susceptible to the effect of the heat which is emitted from the fixing device 9, it is possible to suppress clogging of the waste tonner inside the branch pipeline passage 83.

Further, according to the embodiment, it is possible to suppress clogging of the waste toner inside the branch pipeline passage 83, even when a wall which separates the collecting pipeline passage 81 and the fixing device 9 or a mechanism which covers around the collecting pipeline passage 81 and forcibly cools with the airflow formation fan, etc. are not provided. Therefore, it is possible to reduce the cost and the size of the image forming apparatus 100 (suppression of increase in cost and size).

### Others

So far, the present invention has been described based on the specific embodiment, however, the present invention is not limited to the embodiment which is described above.

In the embodiment which is described above, the image forming apparatus is a monochrome image forming apparatus which includes only one photosensitive member, however, the present invention is also possible to apply to a color image forming apparatus. In the case, it may be configured as a tandem type in which a plurality of image forming units are disposed along the image forming surface of the intermediary transfer belt according to the embodiment which is described above. Each image forming unit is configured to include a photosensitive member and process means (charging means, exposure means, developing means, photosensitive member cleaning means) which act on the photosensitive member, for example, similarly to the embodiment which is described above. Here, the image forming apparatus according to the embodiment, which is described above, may be a monochrome image forming apparatus which is configured so that only parts and units which are necessary for forming a black monochrome image are retained among parts and units of such a tandem type color image forming apparatus. That is, the image forming apparatus according to the embodiment, which is described above, may be configured so that elements which are necessary for performing yellow, magenta, and cyan image forming in the tandem type color image forming apparatus are removed, while elements which are necessary for performing black image forming are retained. In such color image forming apparatus and monochrome image forming apparatus, a relative position of the primary transfer portion, a relative position of the secondary transfer portion, and a relative position of the waste toner container for black inside the casing of the image forming apparatus are essentially the same. The present invention may likely apply to such monochrome image forming apparatus.

Further, in the embodiment which is described above, it is described that the cleaning device collects the transfer residual toner from the image bearing member, however, the cleaning device is also able to collect a toner image for a control (toner patch).

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025- 032485, filed February 28, 2025, which is hereby incorporated by reference herein in its entirety.

What is claimed is:

1. An image forming apparatus comprising:
a single image forming portion including a plurality of discharging portions for discharging waste toner and configured to form a toner image on a recording material;
a fixing device including a heat rotatable member configured to apply heat to the recording material and configured to fix the toner image formed by the image forming portion onto the recording material;
a plurality of branch pipeline passages connected to the plurality of the discharging portions, respectively, the waste toners discharged from the plurality of the discharging portions, respectively falling inside the plurality of the branch pipeline passages, respectively; and
a merging pipeline passage connected to the plurality of the branch pipeline passages, respectively and configured to receive the waste toners from the plurality of branch pipeline passages,
wherein the merging pipeline passage is located above the heat rotatable member with respect to a vertical direction and at a position overlapping with the heat rotatable member with respect to a horizontal direction, and
wherein any of the plurality of branch pipeline passages is located above the heat rotatable member with respect to the vertical direction and at a position nonoverlapping with the heat rotatable member with respect to the horizontal direction.

2. The image forming apparatus according to claim 1, wherein the fixing device further includes a casing configured to accommodate the heat rotatable member, and
wherein at least one of the plurality of the branch pipeline passages is located at a position overlapping with the casing with respect to the horizontal direction.

3. The image forming apparatus according to claim 1, wherein the plurality of the branch pipeline passages includes at least a first branch pipeline passage and a second branch pipeline passage, and
wherein the heat rotatable member is located between the first branch pipeline passage and the second branch pipeline passage with respect to the horizontal direction.

4. The image forming apparatus according to claim 1, wherein the image forming portion further includes a photosensitive member on which the toner image is formed, an intermediary transfer member on which the toner image is transferred from the photosensitive member, a first cleaning device configured to collect the waste toner from the photosensitive member and a second cleaning device configured to collect the waste toner from the intermediary transfer member, and
wherein the plurality of the discharging portions include a first discharging portion configured to discharge the waste toner from the first cleaning device and a second discharging portion configured to discharge the waste toner from the second cleaning device.

5. The image forming apparatus according to claim 4, wherein the image forming portion further includes a developing device configured to supply toner to the photosensitive member and form the toner image on the photosensitive member, and
wherein the plurality of the discharging portions include a third discharging portion configured to discharge the waste toner from the developing device.

6. The image forming apparatus according to claim 1, wherein at least one of the plurality of the branch pipeline passages is inclined with respect to the vertical direction and is extended in an up and down direction.

7. The image forming apparatus according to claim 6, wherein at least one of the branch pipeline passage inclined with respect to the vertical direction and extended in the up and down direction is inclined so that an upper end portion thereof is located more remote from the heat rotatable member than a lower end portion thereof.

8. The image forming apparatus according to claim 1, further comprising a conveying portion configured to convey the waste toner inside the merging pipeline passage.
